(19) United States
(12) Patent Application Publication
(10) Pub. No.: US 2006/0064287 A1
(43) Pub. Date: Mar. 23, 2006

(54) Method of design using genetic programming

(76) Inventors: David W F Standingford, Bristol (GB); Carren M E Holden, Bristol (GB); Peter C Matthews, Durham (GB)

Correspondence Address: NIXON & VANDERHYE, PC, 901 NORTH GLEBE ROAD, 11TH FLOOR, ARLINGTON, VA, 22203, US

(21) Appl. No.: 10/538,147

(22) PCT Filed: Dec. 2, 2003
(86) PCT No.: PCT/GB03/05175

§ 371 Date: Jun. 7, 2005

(30) Foreign Application Priority Data
Dec. 10, 2002 (GB) 0228751.4

(51) Int. Cl. G06F 17/10

(52) U.S. Cl. 703/2

(57) ABSTRACT

A method of design is provided comprising the steps of parameterising a design space according to a set of parameters; creating a parent population of relationships by random selection amongst the set of parameters; encoding the parent population into a population of functional elements, each functional element comprising terminal nodes and functional nodes and having a signature that corresponds to the total of terminal nodes and functional nodes; grouping functional elements into clusters according to the similarity between functional elements; creating an offspring population of functional elements by performing genetic operations on the parent population; and reporting results by grouping functional elements into clusters, ranking the complexity of functional elements according to their signature and presenting a plurality of functional elements from the clusters according to the ranking.

This invention relates to the field of design and, in particular, to design using genetic programming.

The development of genetic programming has provided a new and useful tool in computer-assisted problem solving. A good introduction to genetic programming is provided in U.S. Pat. No. 5,136,686 to Koza.

Genetic programming is a method of searching the space of functional forms to identify a function that best solves a problem. The design space will comprise design parameters and objectives. Genetic programming relies on concepts such as cross-breeding, mutation, natural selection and survival of the fittest, such that a computer can evolve an optimum solution to a problem from sets of parameters and operators. Thus, evolution of the best solutions in genetic programming can be compared to evolution of the fittest species in the animal kingdom. The validity of a proposed solution may be returned as a fitness value, thereby allowing the best solution to be identified.

Genetic programming starts with the assumption that there is little or no explicit design domain knowledge about the relationship between the various design parameters. Therefore, it is not known which of the design parameters play an important role in the design domain. The approach is to capture a super-set of design parameters that will be pruned later to the most significant set. Previous work provides a method of ranking and, therefore, identifying the less relevant design parameters that can be discarded at a later stage.

In order for the design solution to be effective, it is essential for the genetic program to assess the validity of proposed relationships with a model of the design space. The model might be a simple database containing results from experiments, a curve fit to the design space (such as a self-organising map or a spline) or a specific representation of the design space (such as an ontology).

The design space requires a parameterisation such that the design space can be populated using these design parameters. Design parameterisation may comprise geometrical dimensions (e.g. diameter, length, curvature), material properties (e.g. density, stiffness) or objective values (e.g. cost, weight, drag). Once the design space has been parameterised, a design database must be populated according to this parameterisation. This might be performed by reviewing some or all existing designs and encoding them according to the parameterisation or by creating a series of designs from the parameterisation and analysing them. For example, forming the population may comprise forming simple relationships between design parameters (e.g. diameter times length).

A key aspect of our implementation of genetic programming is the use of clustering. Clustering enables similar objects within the evolving design space to be grouped together: this allows a higher level of sophistication when selecting which objects are to be retained, discarded, used in cross-breeding or mutated during the next evolutionary stage. A clustering technique that we have used is the ‘partitioning around medoids’ (PAM) algorithm described in ‘Finding Groups in Data: An Introduction to Cluster Analysis’ by Kaufmann and Rousseeuw (1990) and published by John Wiley. Other clustering techniques could equally well be used.

Given a set of objects and a metric between all pairs of objects, the aim is to partition the set of objects into separate clusters such that for each cluster, the distance between objects within that cluster is small, while the distance between objects from different clusters is large. Further, within each cluster a single object is identified to be the representative element for this cluster. This representative object will be selected such that it has the smallest average distance between it and all the other elements within its cluster. This representative object is called the medoid of the cluster.

According to a first aspect, the present invention resides in a method of design comprising the steps of:
(a) parameterising a design space according to a set of parameters;
(b) creating a parent population of relationships by random selection amongst the set of parameters;
(c) encoding the parent population into a population of functional elements, each functional element comprising terminal nodes and functional nodes and having a signature that corresponds to the total of terminal nodes and functional nodes;
(d) grouping functional elements into clusters according to the similarity between functional elements;
(e) creating an offspring population of functional elements by performing genetic operations on the parent population; and
(f) reporting results by grouping functional elements into clusters according to step (d) above, ranking the complexity of functional elements according to their signature and presenting a plurality of functional elements from the clusters according to the ranking.

Grouping functional elements into clusters according to the similarity between functional elements inherently leads to clusters with well-separated medoids.

Advantageously, the reporting provides designers with a range of underlying relationships rather than a single design solution because evolution is performed by genetic breeding of the clustered population and this, in turn, allows the best functional elements from each of the clusters to be reported.

Optionally, genetic operations may be performed on an intra-cluster basis (i.e. treating each cluster in isolation), on an inter-cluster basis (i.e. moving functional elements or parts of functional elements between clusters) or as a combination of intra- and inter-cluster operations.

Preferably, the functional elements are grouped into clusters to minimise the average distance between functional elements in the cluster. Preferably, the distance between functional elements is calculated by firstly creating, for each of the functional elements of the pair, a vector comprising a frequency count of each different terminal node and each different functional node in the pair of functional elements and then by taking the absolute difference between the vectors. This provides a computationally inexpensive way of determining similarity between pairs of functional elements.

The method of the present invention may further comprise the step of determining a fitness value of a functional element in accordance with how favourably the functional element compares to the design space. Optionally, the fitness value is determined such that it is inversely proportional to the length of the functional element. The fitness value of an individual functional element is a useful indication of how well that functional element matched the design space and so can be used to identify promising candidates that should be retained during genetic operations or are good candidates for recombination. In addition, overall trends in the fitness values of the functional elements can be used to determine how the design exercise is progressing.

Advantageously, the method of the present invention may further comprise evaluating the aptness of functional elements within a pair for a recombination genetic operation by determining a correlation factor proportional to their similarity and wherein step (e) includes performing recombination genetic operations of pairs of functional elements selected according to their correlation factor. Preferably, a correlation factor for each functional element of the pair is determined that is inversely proportional to the length of that functional element. The subset of individual correlation factors an be useful in determining functional elements that relate well to the design problem being considered. This is because strong relationships, and hence their functional elements, will generally produce low individual correlation factors when compared against other functional elements.

Optionally, step (c) comprises encoding the functional elements to have tree structures of terminal and functional nodes and wherein recombination of functional elements is performed by swapping sub-trees between the pair of functional elements. Recombination may be performed only between functional elements that are members of the same cluster. Alternatively, recombination may be performed between functional elements that are members of the same cluster before being performed between functional elements that are members of different clusters. The latter method helps maintain diversity throughout the entire population.

Preferably, step (c) comprises encoding the functional elements to have tree structures of terminal and functional nodes and wherein step (e) includes performing mutation genetic operations of functional elements by substituting a sub-tree with a randomly-generated sub-tree.

Optionally, step (e) includes performing elitism genetic operations by retaining functional elements with the highest fitness values unchanged or performing introduction genetic operations by introducing new randomly-generated functional elements. This method is to the benefit of diversity and helps mitigate the problems of in-breeding.

Preferably, steps (d) and (e) are repeated to produce successive offspring populations, the preceding offspring population acting as the parent population for each genetic operation step. This is beneficial because better functional relationships may take many iterations to evolve. Steps (d) and (e) may be repeated successively until a single fitness value or a plurality of fitness values above a certain threshold level is or are achieved. Alternative methods may be used to determine when to stop the iterative process of generating new populations, for example by testing the convergence of the best fitness values or an average of the best or all of the fitness values.

The present invention also extends to a computer for use with any of the methods defined herein above, when programmed to perform steps (a) to (f) and to a computer program product comprising program instructions for causing a computer to operate as described immediately before.

In order that the invention can be more readily understood, reference will now be made, by way of example only, to the accompanying drawings in which:

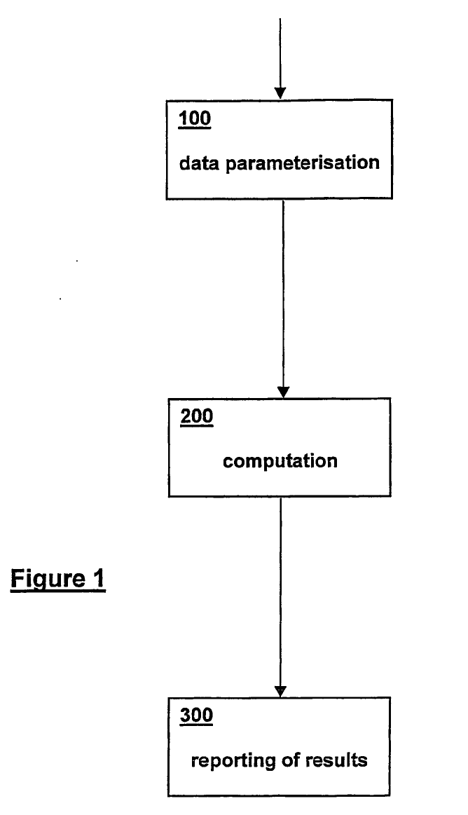

FIG. 1 is a block diagram of the method of this invention;

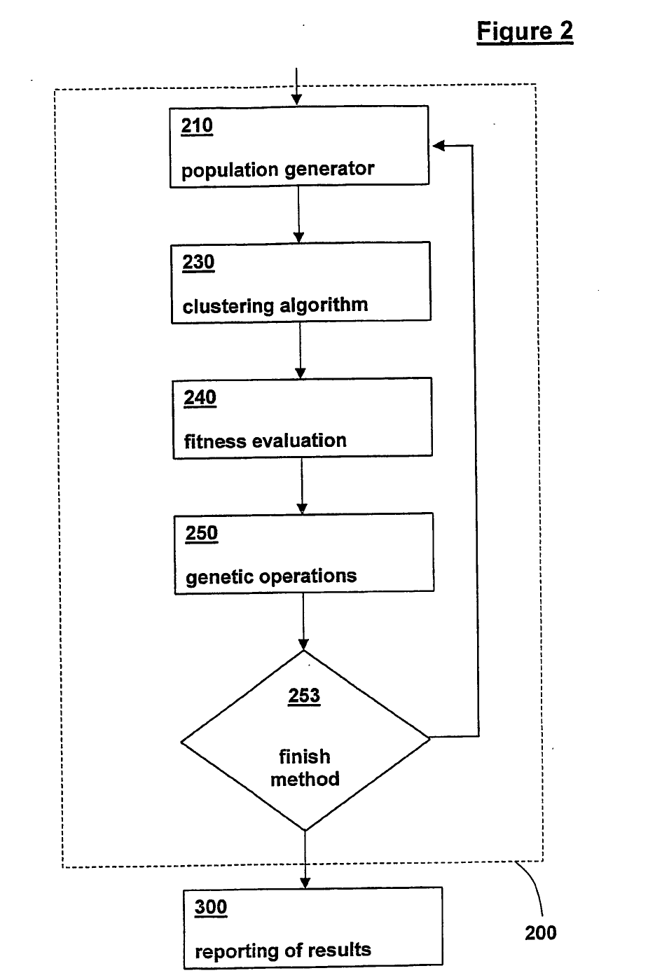

FIG. 2 is a block diagram of part of the method illustrated in FIG. 1, showing the computation stage in greater detail;

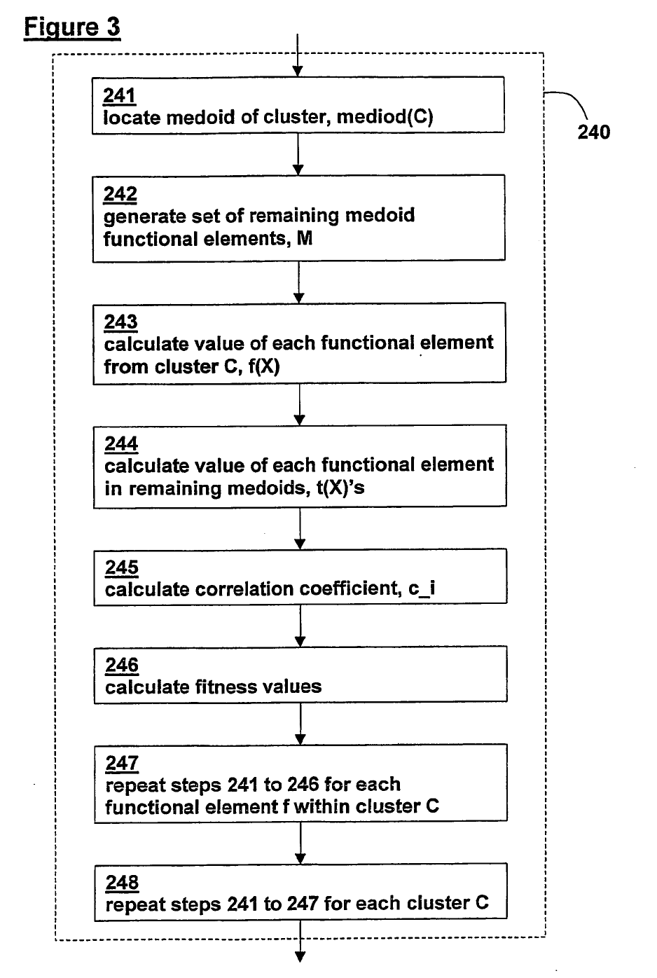

FIG. 3 is a block diagram showing the fitness evaluation stage illustrated in FIG. 2 in greater detail; and

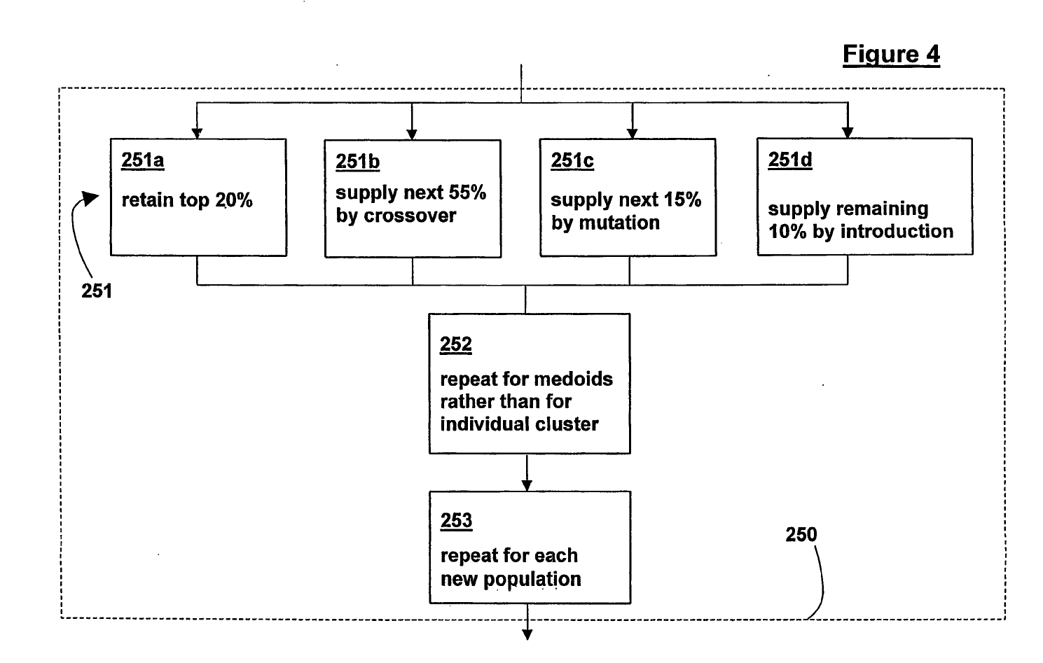

FIG. 4 is a block diagram showing the genetic operations stage illustrated in FIG. 2 in greater detail.

In order to aid understanding of the present invention, an exemplary embodiment of a method of the invention will now be described. This embodiment can be split into three parts, as illustrated in FIG. 1:

(i) data parameterisation at 100;

(ii) computation at 200; and

(iii) reporting results at 300.

As an overview, details of these three parts are given below.

Data Parameterisation 100

The design space is parameterised and then populated using these design parameters. This is achieved by reviewing some or all existing designs and encoding them according to the parameterisation and by creating a series of designs from the parameterisation and analysing them.

Computation 200

The computation stage comprises four steps, as shown in FIG. 2:

(i) population generation at 210;

(iii) running the clustering algorithm at 230;

(iii) fitness evaluation at 240; and

(iv) performing genetic operations at 250.

The population generator at 210 uses relationship encoding to produce an initial population of relationships by randomly combining small subsets of the design parameters. These relationships are encoded as functional elements with terminal nodes and functional nodes linked together in a tree-like structure. Terminal nodes are either numerical constants or design parameters, whilst functional nodes are mathematical functions. Each function has a signature related to the number of arguments it takes.

The clustering algorithm at 230 not only ensures that fitter relationships are more likely to be used for recombination within a cluster, but also ensures that diversity is preserved by having a proportion of elements from different clusters used in recombination (akin to cross-breeding). Each population generation is clustered according to the similarity of functional elements, i.e. a preferential grouping together of functions that share a large number of terminal and functional nodes. As fitness evaluation uses the correlation factor of the mapped function values, similar functional elements will achieve artificially high fitness scores. By clustering such similar functional elements together, the fitness function can exclude these similar elements in its evaluation. Clustering similar relationships is achieved by the identification of local medoids and grouping functional elements around these local medoids according to their distance from each of the medoids. Measuring the distance between functional elements is performed using a ‘hash’ metric, as explained in greater detail below.

Fitness evaluation at 240 is performed to test each population generation against the design space model. An error measure is computed for each functional element that represents how much it diverges from the design space model. The fitness score of each functional element is inversely proportional to its error and also to its length. This ensures that simple relationships that describe the design space well achieve high fitness scores and are thus more likely to be retained during the design process and are more likely to be used in genetic operations such as recombination.

A number of genetic operations are performed at 250 to produce the next population generation. The most common genetic operation is recombination: this is a stochastic process that is performed on relationship pairs within a cluster selecting with greater probability individuals with high correlation factors. A correlation factor is computed for each functional element of a relationship pair within a cluster. The correlation factor is proportional to how similar the relationships are and inversely proportional to that functional element's length. Dividing by the functional element's length ensures that complexity is penalised and simplicity is promoted.

In addition to recombination, other genetic operations are performed such as elitism (maintaining functional elements with the highest fitness values from each generation within a cluster), mutation (substitution of a randomly-chosen functional form into a randomly-chosen node of a functional element) and introduction of new randomly generated functional elements. The latter pair of genetic operations introduce new terminal and functional nodes into the population, thereby encouraging diversity.

Reporting Results 300

The manner in which the final population is reported according to the present invention is highly advantageous. The aim is to provide designers with a greater insight of the design space. This is accomplished by presenting the designer with a set of underlying relationships that determine the shape of the design space. To ensure that the results are reported with clarity, the functional elements are grouped according to the design parameters (terminal nodes) they contain, using the same algorithm as for the clustering method mentioned above. Moreover, the functional elements of each cluster are ranked according to their complexity, with complexity being simply measured as the total number of nodes the functional element contains. The least complex relationships are presented first, even if they have relatively low fitness values, subject to the condition that functional elements with a fitness value that falls below a threshold value are not reported.

The reported results can thus be used to aid a design exercise because they provide information on the underlying relationships that determine the shape of the design space. This, for example, shows designers advantageous combinations of design parameters that may then be considered and exploited during the continuing design process. This diversity of information is lost where a genetic programme provides only a single ‘best’ answer.

Against this overview, the computation step 200 of this embodiment of the invention will now be described in greater detail.

The following description will use terminology as follows. Initially, there is a set of terminal components T and a set of operators O. Combinations of some of the terminal components T and some of the operators O are combined to form the functional elements of the population for the next generation, the terminal components T becoming the terminal nodes referred to above and the operators O becoming the functional nodes referred to above. The terminal components T represent the design parameters and objectives, whilst the operators O contain the mathematical operations that can be performed. Each operator O has its own signature s, namely, the number of arguments it takes (e.g. sin(x) and sqrt(x) both have a signature of 1, the addition of x+y has a signature of 2 and so on). In addition, there will be a database of previous examples X, these being the examples on which the parameterisation was based.

Returning now to the steps of the computation, the steps are performed as follows.

Population Generator 210

Relationship encoding proceeds with the relationships made by the population generator at 210 being encoded as functional elements that have terminal nodes and functional nodes. The terminal nodes are either numerical constants or design parameters including objectives. The functional nodes are mathematical functions, for example the arithmetic operations (+, ×, etc) or other functions (sin, √, etc). Each function has a signature s related to the number of arguments it takes. The arguments form the children of these functional nodes and can be either terminal nodes or further functional nodes (i.e. a sub-tree). This encoding permits complex relationships to be constructed by simply inserting new sub-trees into existing trees.

An initial population of functional elements is randomly generated as follows. A random functional element f is created by first randomly selecting an operator from the set of available operators O, i.e. fεO. This functional element f will have the signature s. From T, the set of terminal components, s are randomly chosen as the arguments for the functional element f. Any particular terminal component may be a single parameter (such as A). This combination of terminal components and operator in this manner becomes the random functional element f of the population for the next generation.

Clustering Algorithm 230

To enable clustering, there is a requirement for a metric between pairs of functional elements, i.e. a measure of how far apart they are within the functional space. This operation is performed by the hash metric. For example, the functions A+B and B+A are the same and should be identified as such whilst the hash metric should identify that A+B is closer to A*B than to D−E. This enables the functional elements f of the population to be clustered based on their functional similarity. The functional similarity between functional elements f₁ and f₂ is measured by first generating a hash vector for these functional elements. The hash vector is calculated for each functional element, this vector being a frequency count of the symbols in a functional element f (i.e. the number of occasions of each term and operator). The hash metric is then calculated by taking the absolute difference between the two normalised hash vectors and this hash metric provides a measure of the symbolical difference between the functional elements f₁ and f₂.

For example, A+B+C will be represented as A:1 B:1 C:1 +:2 and A+B−A*C as A:2 B:1 C:1 +:1 −:1 *:1. This, in effect, transforms a functional element into a hash vector. The hash vector representation for the above two examples would be in the form of (A,B,C,+,−,*,/), specifically: (1,1,1,2,0,0,0) and (2,1,1,1,1,1,0). Before taking the difference to form the hash metric, these hash vectors are normalised by dividing through by the sum of the frequencies. In the above examples these values would be: 1+1+1+2=5 and 2+1+1+1+2=7, respectively. Finally, the hash metric is obtained simply as the distance between two functional forms. This is given by the sum of the components from the vector of the absolute difference d between the two normalised hash vectors. In the above example, this would be:

$$\begin{matrix}d = sum ( abs ( \frac{( 1 , 1 , 1 , 2 , 0 , 0 , 0 )}{5} ) - ( \frac{( 2 , 1 , 1 , 1 , 1 , 1 , 0 )}{7} ) ) \\ = sum ( abs ( - 0.09 , 0.06 , 0.06 , 0.26 , - 0.14 , - 0.14 , 0 ) ) \\ = 0.75\end{matrix}$$

Finally, the precise method of clustering is based on a ‘partitioning around medoids’ algorithm. Further details on this method can be found in the book “Finding Groups in Data: An Introduction to Cluster Analysis” by Kaufman and Rousseeuw published by John Wiley. In essence, the method relies on identifying cluster centres (i.e. the medoids) and subsequently grouping functional elements around their nearest medoid. In essence, a functional element is chosen at random and designated to be the first medoid. Calculating the distance from each functional element f to each medoid is found using the hash metric routine already described. The next medoid is chosen to be the functional element furthest away from the first medoid. A further medoid is then chosen to be the functional element furthest away from the other medoids and so on until there is a medoid for each of the desired number of clusters. The number of medoids, and hence clusters, to be used in the method is chosen to be at least the number of independent relations the user wishes to extract from the design domain before the method is performed. Medoids and non-medoids are then swapped and the set of medoids tested for dissimilarity. This process of swapping and testing is continued until the dissimilarity can be driven no lower.

Fitness Evaluation 240

The fitness value of each functional element is calculated on a cluster-by-cluster basis, as follows and as illustrated in FIG. 3.

At 241, a cluster C is picked arbitrarily and the functional element f that is the medoid of that cluster C, where the medoid is labelled as medoid(C), is recalled as determined by the clustering algorithm. Specifically, the clustering algorithm has already calculated the distances between all pairs of functional elements and has assigned each functional element to a cluster—it is then straightforward to determine the medoid of that cluster as it is the functional element with the smallest average distance between itself and other functional elements within the cluster.

At 242, a set containing all of the remaining medoid functional elements M′=M\medoid(C) is generated (where M represents the set of all medoids).

At 243, the value that a particular functional element f, where f is chosen not to be the medoid from the cluster C, takes for each element of the examples database X is calculated, where this value is labelled f(X) and is a vector.

At 244, the values that each functional element in the remaining medoids (labelled tᵢ where tᵢεM′) takes is computed (this will be a set of tᵢ(X)'s, put together as a matrix).

At 245, the correlation coefficient cᵢ between f(X) and each t(X) is computed for all of tᵢεM′.

At 246, the fitness value of the particular functional element f is given by calculating the sum of the squares of the correlation coefficients cᵢ divided by the length of f (counted by the total number of nodes in f).

At 247, steps 241 to 246 are repeated for each functional element f within the cluster C.

At 248, steps 241 to 247 are repeated for each cluster C in the population.

Genetic Operations 250

Genetic operations are performed on each cluster C to populate the next generation as a number of steps, labelled as 251 to 253 in FIG. 4.

Initially at 251 genetic breeding is performed internally within each of the individual clusters. The intra-cluster genetic breeding proceeds in four different ways, as follows.

At 251a, the functional elements having fitness values within the top 20% of the fitness value range for the entire population are identified and these functional elements are placed into the next generation without modification (this provides a form of elitism where the best from each generation are retained in the next generation). These functional elements f will make up 20% of the next population.

At 251b, the functional elements comprising the following 55% of the population for the next generation are produced by the crossover operation—pairs of functional elements are selected in a pseudo-random fashion from the parent generation (including elite members from above). Recall that these functional elements are represented as functional trees and within each of these functional trees, a node and hence sub-tree is selected at random and the two sub-trees from the two functional forms are swapped thereby generating two new offspring which are placed into the next generation The randomness of selecting functional elements is modified by imposing a probability of selection that is proportional to the relative fitness value of each functional element, i.e. a roulette wheel selection is adopted. Moreover, whereas clustering is performed by looking for strong similarity between functional elements, crossover is performed preferentially on dissimilar functional elements.

At 251c, the functional elements comprising the following 15% of the population for the next generation are produced by mutating randomly-selected functional elements of the population. Here, the randomness of the selections is uniform rather than being of the roulette wheel type. Mutation is performed by selecting a random node from within the functional element and replacing it with a randomly generated sub-tree (using the same method that generates the initial population) thereby modifying an existing functional element.

At 251d, the remaining 10% of the population for the next generation is produced by adding randomly generated functions (again, using the same method that generates the initial population) thereby introducing functions that are new in toto.

Hence, genetic breeding at 251 is performed in four different ways. Of course, it will be appreciated that the relative weighting between the four ways can be freely varied from the currently-preferred 20:55:15:10 scheme described above.

After the intra-cluster genetic breeding, step 251 above is repeated at 252 on the set of all medoids M′. This inter-cluster genetic breeding is done to provide a degree of crossover between the clusters.

Once the above genetic breeding is complete, steps 230 to 252 of FIGS. 2 to 4 are repeated at 253 for each new population until some stop criterion is reached. For example, the stop criterion may be until a predetermined number of generations have been produced or until a threshold value has been achieved for a particular design requirement.

Once step 253 determines that the stop criterion has been met, the results of the method can be presented at 300 in accordance with the method described above.

Three examples used to test the method of the invention will now be described.

Example of Two Independent Relationships

This dataset was generated from four parameters (x₁, . . . , x₄), and two relationships. The relationships were:
f₁=x₁+x₂
f₂=x₃×x₄

These relationships can be interpreted as, for example, a manufacturing time required (f₁) and an area covered (f₂). These two objectives are independent of each other. The aim is to identify and to report these two independent relationships from data alone.

The dataset was populated by selecting x₁, . . . , x₄ to take random values between 0 and 1. For each of these ‘design vectors’, f₁ and f₂ were computed to provide a six-dimensional vector. A total of fifty example datasets were generated. To this, random gaussian noise with a mean of 0 and a standard deviation of 0.1 was added to simulate real world data.

The genetic algorithm was allowed to run on the simulated data for ten generations, and the population at each generation was maintained at about sixty individuals. Each generation of individuals was clustered into five groups according to the symbols used in each individual.

After ten generations, the top-ranked relationships were reported. Among these, the original relationships were reproduced and ranked second and fourth.

Example of Two Related Relationships

This dataset was generated from two parameters (x₁ and x₂), and two relationships. The relationships were:
f₁=x₁+x₂
f₂=x₁×x₂

These can be interpreted as a plate design, where the two design parameters represent the length and width of the plate. The relationships then can be interpreted as f₁ being proportional to the perimeter length and f₂ representing the area of the plate.

The dataset was populated by selecting x₁ and x₂ to take random values between 0 and 1. For each of these, f₁ and f₂ were computed to provide a four dimensional vector. A total of fifty example datasets were generated. To this, random gaussian noise with a mean of 0 and a standard deviation of 0.1 was added to simulate real world data.

The genetic algorithm was allowed to run for ten generations, and the population at each generation was maintained at about sixty individuals. Each generation of individuals was clustered into five groups according to the symbols used in each individual.

After ten generations, the top-ranked relationships were reported. Among these were the original relationships, ranked second and third. The fact that neither ranked first is largely due to the penalty function: the top-ranking relationship contained fewer symbols and was therefore the shortest possible expression (but not relevant in this case).

Example of Two Partly-Related Relationships

This dataset was generated from three parameters (x₁, x₂ and x₃), and two relationships. The relationships were:
f₁=x₁+x₂
f₂=x₂÷x₃

These can be interpreted as a roll-cutting domain, where rectangular sheets are cut from a roll of material (e.g. paper or steel). The design parameters in this case are: x₁ is the length of sheet rolled out, x₂ is the width of the roll, and x₃ represents the difficulty of cutting the material. The first relationship represents the perimeter of the cut sheet and the second represents tool life based on this cut length and material hardness.

The dataset was populated by selecting x₁, x₂ and X₃ to take random values between 0 and 1. For each of these, f₁ and f₂were computed to provide a four dimensional vector. A total of fifty example datasets were generated. No noise was added to this data set. Again, the original equations were identified in the top-ranking relationships.

The person skilled in the art will appreciate that modifications can be made to the embodiments described hereinabove without departing from the scope of the invention. Many of these modifications have been indicated throughout the preceding pages.

For example, the method of assessing the fitness value of a functional element described above may be varied. One example of a suitable alternative is Pareto ranking. A functional element can be assigned a fitness value by counting the number of inferior functional elements that perform worse than it does on all measures (i.e. the functional elements that compare less favourably with the design space model). The greater the number of inferior functional elements, the higher the fitness value.

1. A method of design comprising the steps of:
(a) parameterising a design space according to a set of parameters;
(b) creating a parent population of relationships by random selection amongst the set of parameters;
(c) encoding the parent population into a population of functional elements, each functional element comprising terminal nodes and functional nodes and having a signature that corresponds to the total of terminal nodes and functional nodes;
(d) grouping functional elements into clusters according to the similarity between functional elements;
(e) creating an offspring population of functional elements by performing genetic operations on the parent population; and
(f) reporting results by grouping functional elements into clusters according to step (d) above, ranking the complexity of functional elements according to their signature and presenting a plurality of functional elements from the clusters according to the ranking.

2. The method of claim 1, wherein the functional elements are grouped into clusters to minimise the average distance between functional elements in the cluster.

3. The method of claim 2, wherein the distance between functional elements is calculated by firstly creating, for each of the functional elements of the pair, a vector comprising a frequency count of each different terminal node and each different functional node in the pair of functional elements and then by taking the absolute difference between the vectors.

4. The method of claim 1, wherein a fitness value of a functional element is determined in accordance with how favourably the functional element compares to the design space.

5. The method of claim 4, wherein the fitness value is determined such that it is inversely proportional to the length of the functional element.

6. The method of claim 1, further comprising evaluating the aptness of functional elements within a pair for a recombination genetic operation by determining a correlation factor proportional to their similarity and wherein step (e) includes performing recombination genetic operations of pairs of functional elements selected according to their correlation factor.

7. The method of claim 6, wherein a correlation factor for each functional element of the pair is determined that is inversely proportional to the length of that functional element.

8. The method of claim 6, wherein step (c) comprises encoding the functional elements to have tree structures of terminal and functional nodes and wherein recombination of functional elements is performed by swapping sub-trees between the pair of functional elements.

9. The method of claim 6, wherein recombination is performed only between functional elements that are members of the same cluster.

10. The method of claim 6, wherein recombination is performed between functional elements that are members of the same cluster before being performed between functional elements that are members of different clusters.

11. The method of claim 1, wherein step (c) comprises encoding the functional elements to have tree structures of terminal and functional nodes and wherein step (e) includes performing mutation genetic operations of functional elements by substituting a sub-tree with a randomly-generated sub-tree.

12. The method of claim 4, wherein step (e) includes performing elitism genetic operations by retaining functional elements with the highest fitness values unchanged.

13. The method of claim 1, wherein step (e) includes performing introduction genetic operations by introducing new randomly-generated functional elements.

14. A method according to claim 1, wherein steps (d) and (e) are repeated to produce successive offspring populations, the preceding offspring population acting as the parent population for each genetic operation step.

15. The method of claim 14, wherein steps (d) and (e) are repeated successively until a single fitness value or a predetermined plurality of fitness values above a certain threshold level is or are achieved.

16. (canceled)

17. A computer for use with the method of claim 1, when programmed to perform steps (a) to (f).

18. A computer program product comprising program instructions for causing a computer to operate in accordance with claim 17.
